(19) United States
(12) Patent Application Publication
(10) Pub. No.: US 2005/0005656 A1
(43) Pub. Date: Jan. 13, 2005

(54) Handcuffs including luminescent material

(76) Inventor: James John Seebock, Henderson, NV (US)

Correspondence Address: James J. Seebock, 2417 Motif Ct., Henderson, NV, 89052, US

(21) Appl. No.: 10/618,371

(22) Filed: Jul. 12, 2003

(51) Int. Cl. E05B 75/00

(52) U.S. Cl. 70/16

(57) ABSTRACT

Methods and apparatuses are disclosed for providing illumination for physical restraint devices, such as handcuffs. In some embodiments, the handcuffs may include a luminescent material. The luminescent material used may be the type that utilizes energy from a light source to provide light when the light source is removed, such as phosphorus. Alternately, the luminous material may be “self-luminous” and not utilize an external light source to provide light. Exemplary self-luminous materials may include tritium.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of the Invention

The present invention generally relates to handcuffs and/or physical restraint devices in general. More particularly, the invention relates to handcuffs that include illumination.

2. Description of Related Art

Handcuffs are ubiquitous in the various fields of law enforcement. Great care is exercised by law enforcement officers to insure that handcuffs, when applied, are done so in a safe and secure manner. Handcuffs 5, such as those shown in FIG. 1, typically include a jaw 10 and a cheek 12, which may be pivotally coupled to one another such that the jaw 10 engages into the cheek 12. When the cheek 12 is engaged into jaw 10 a key 14 (shown in FIG. 6) may be used in order to unlock handcuffs 5. Handcuffs 5 typically include symmetric portions 5A (shown unlocked) and 5B (shown locked) preferably connected via a chain or hinge 15. To unlock the handcuffs 5, a flag end 14A of the key 14 may be inserted into a primary locking mechanism 16 such that an annular opening 14B of the key 14 encloses a primary lock pin 16A. When the handcuffs 5 are locked as shown in portion 5B, jaw 10 may continue engage into the cheek 12 without the ability to recede. To prevent further engagement of jaw 10, handcuffs 5 may include a double locking mechanism 20 or portions 5A and/or 5B. In double locking the handcuffs, a locking pin 14C of key 14 may enter a double lock cavity 20B in the double locking mechanism 20 to manipulate a double lock pin 20A.

Because both the primary locking mechanism 16 and the double locking mechanism 20 often have relatively small apertures, locking and unlocking the handcuffs may be difficult. Also, law enforcement officials routinely administer handcuffs from behind a detainee, possibly limiting the amount of ambient light available and further hampering efforts to lock and unlock the handcuffs. Furthermore, administering the handcuffs at night may exacerbate the ambient light problems and may make it difficult to locate the small apertures of the primary locking mechanism 16 and double locking mechanism 20.

U.S. Pat. No. 6,244,722 (hereinafter '722) to Seebock and U.S. Pat. No. 6,280,046 (hereinafter '046) to Perez attempt to address this problem in similar fashion by integrating a light source into the handcuff key. However, there are several disadvantages to these approaches. For example, both the '722 and '046 patents utilize light sources that require electrical power that may unexpectedly run out, such as if the light source be accidentally left on. Furthermore, activating the light sources of '722 and '046 may require depressing buttons, which may be difficult, especially in low ambient light situations. Another disadvantage of both the '722 and '046 patents is that they contain electrical circuitry which may fail in inclement weather conditions. Thus, a need exists for providing illumination while locking and unlocking handcuffs.

### SUMMARY

The above-described problems may be addressed by including luminescent material with the handcuffs or other physical restraint devices. The luminescent material used may be the type that utilizes energy from a light source to provide light when the light source is removed. Alternately, the luminous material may be “self-luminous” and not utilize an external light source to provide light. Although the luminescent material may be included anywhere within, on, or around the handcuffs, some embodiments may include the luminescent material in the area of the primary locking mechanism and/or in the area of the double locking mechanism of the handcuffs. Accordingly, the luminescent material may be included in the locking pin of the primary locking mechanism and/or the double locking pin of the double locking mechanism.

An alternate embodiment may include the luminescent material in the peripheries of the primary and the double locking mechanisms. For example, one embodiment may include the luminescent material in the keyhole periphery of the primary locking mechanism and also may include the luminescent material in the keyhole pin of the primary locking mechanism. In addition, another embodiment may include the luminescent material on the periphery of the double locking mechanism and also may include the luminescent material on the pin of the double locking mechanism.

Yet another embodiment may include the luminescent material in the keyhole cavity primary locking mechanism and also in the cavity of the double locking mechanism.

### BRIEF DESCRIPTION OF THE DRAWINGS

A better understanding of the present invention may be obtained when the following detailed description of the embodiments is considered in conjunction with the following drawings, wherein like parts have been given like numbers:

FIG. 1 shows handcuffs according to the various embodiments;

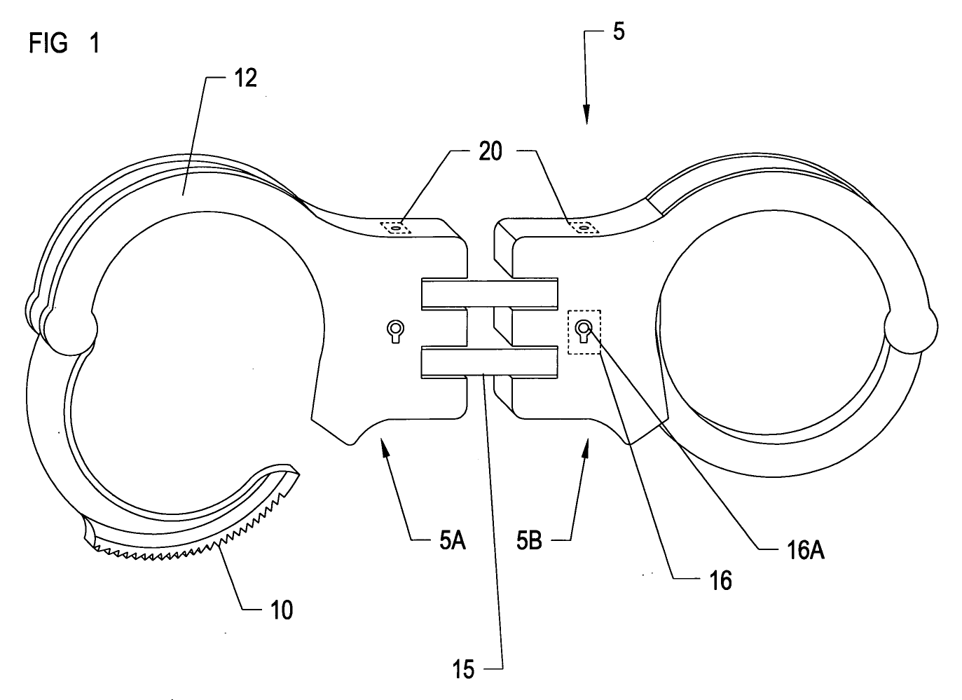

FIG. 2 shows an exploded view of an exemplary primary locking mechanism according to the various embodiments;

FIG. 3 shows an exploded view of an exemplary double locking mechanism according to the various embodiments;

FIG. 4 shows an exploded view of an exemplary keyhole of the primary locking mechanism according to the various embodiments;

FIG. 5 shows an exploded view of the double locking mechanism according to the various embodiments; and

FIG. 6 shows an exemplary handcuff key.

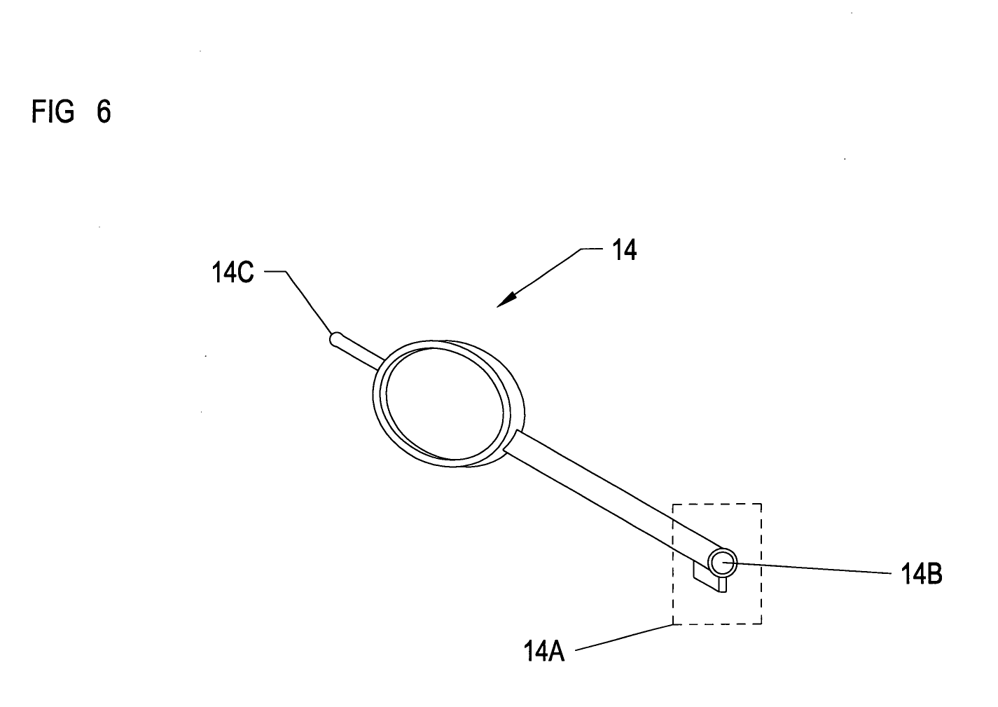

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

In accordance with various embodiments of the present invention, handcuffs may include a luminescent material. The luminescent material used may be the type that utilizes energy from a light source to provide light when the light source is removed. Exemplary luminescent materials that utilize energy from a light source include phosphorus. Alternately, the luminous material may be “self-luminous” and not utilize an external light source to provide light. For example, a self-luminous material may include tritium (an isotope of Hydrogen) that may provide energy for luminescence through radioactive decay.

Although the various embodiments may be described in the context of handcuffs, it should be noted that this disclosure generally applies to the use of luminescent material with any type of physical restraint device, for example, shackles, leg irons, belly chains, and handcuffs of any type.

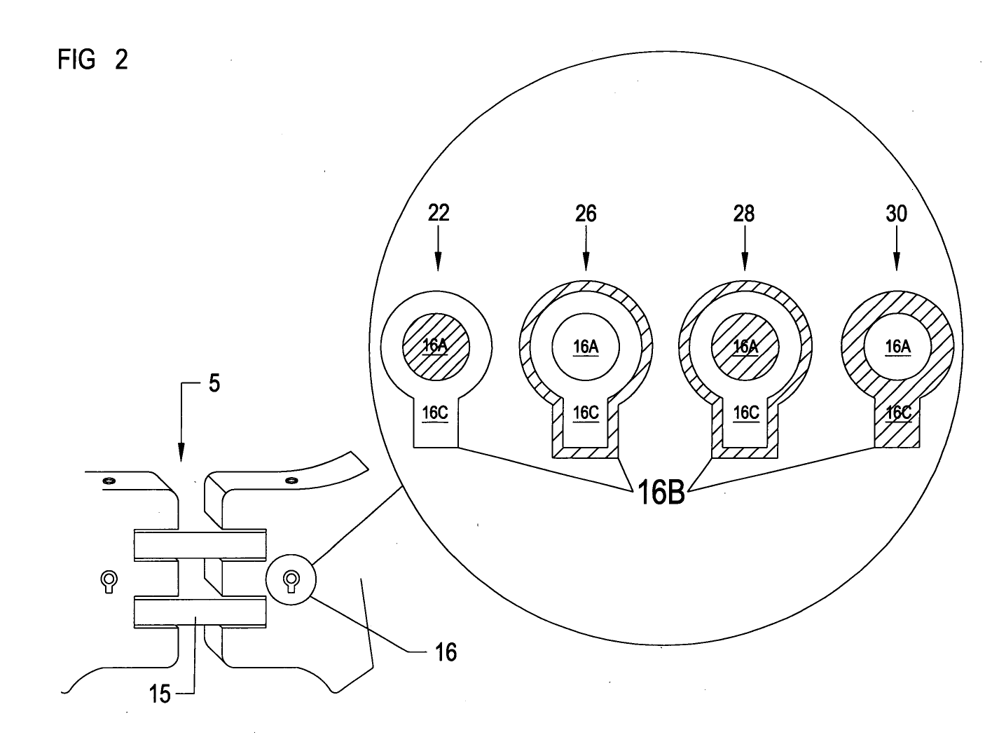

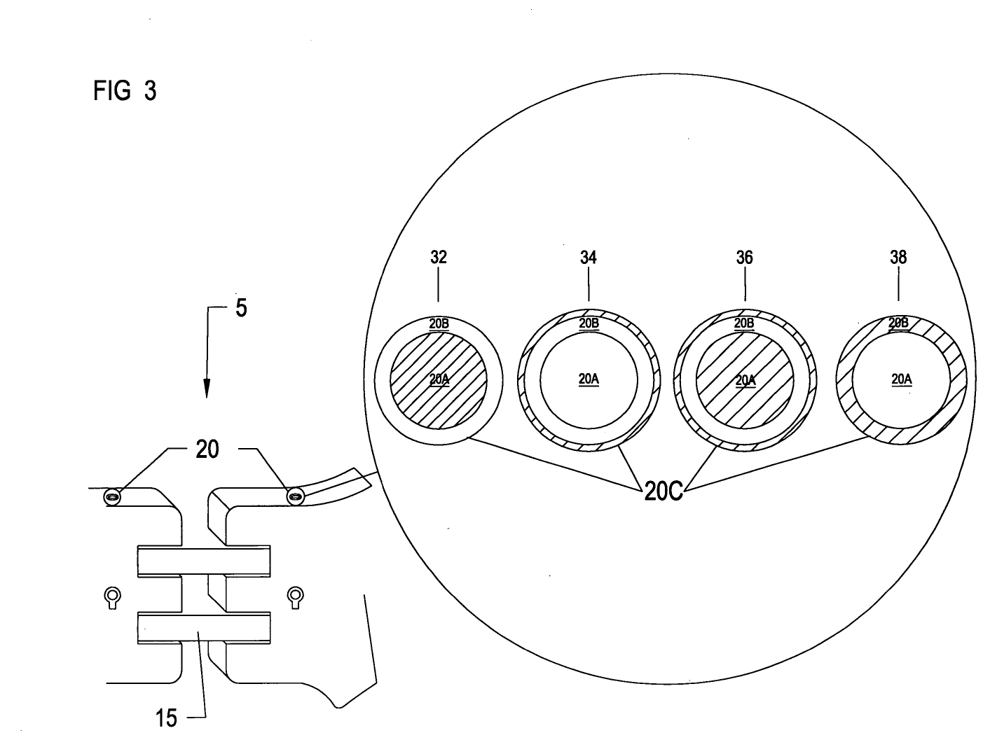

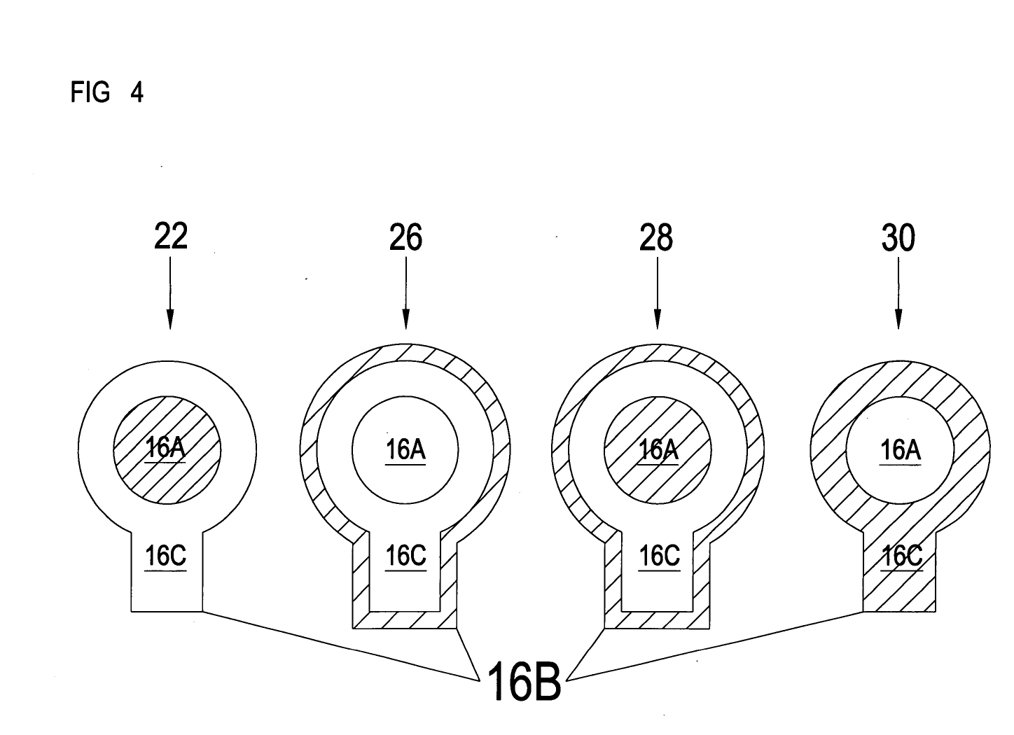

Referring now to FIGS. 2-5 a primary locking mechanism 16 and double locking mechanism 20 are shown including a luminescent material (indicated by the hatched region). By including the luminescent material into the handcuffs 5, the apertures associated with the primary locking mechanism 16 and the double locking mechanism 20 may be easier to locate in adverse lighting conditions. As shown in FIGS. 2 and 4, the primary locking mechanism 16 may comprise a primary lock pin 16A and a primary lock periphery 16B, with a primary lock cavity 16C between the primary lock pin 16A and the primary lock periphery 16B. As shown in FIGS. 3-5, double locking mechanism 20 may comprise a double lock pin 20A which slides along a double lock cavity 20B within a double locking periphery 20C.

FIGS. 2 and 4 show exemplary arrangements for the luminescent material (where the hatched region indicates the luminescent material). One embodiment is shown in arrangement 22, which comprises the primary lock pin 16A including luminescent material. Arrangement 26 depicts another embodiment, in which the primary lock periphery 16B includes luminescent material. Arrangement 28 shows yet another exemplary embodiment, in which the primary lock pin 16A and the primary lock periphery 16B may include luminescent material. Arrangement 30 depicts another embodiment, in which the primary lock cavity 16C may contain luminescent material.

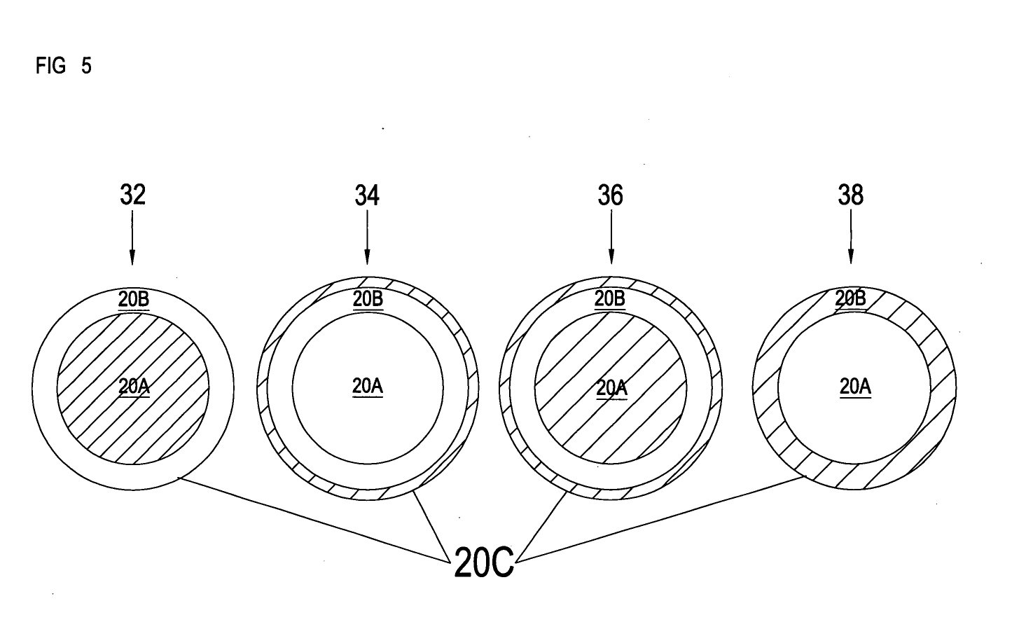

FIGS. 3 and 5 depict exemplary arrangements for the luminescent material. Again, the luminescent material is shown in the hatched region. Arrangement 32 depicts the double lock pin 20A including luminescent material. Arrangement 34 illustrates another embodiment, in which the double lock periphery 20C may include luminescent material. Arrangement 36 depicts yet another embodiment, in which the double lock pin 20A and the double lock periphery 20C may include luminescent material. Arrangement 38 shows still another embodiment in which the double lock cavity 20B may contain luminescent material.

Thus, with a luminescent material included in various portions of the handcuffs as disclosed above, the primary and double locking mechanisms may be more readily located in adverse lighting conditions. Also, because the material may be self-luminous, electrical power sources such as batteries may not be required.

Numerous variations and modifications will become apparent to those skilled in the art once the above disclosure is fully appreciated. For example, while the luminescent material is shown located in specific areas, the luminescent material may be included anywhere in, on, around, or about the handcuffs. In addition, although some embodiments may include the luminescent material on both locking mechanisms of the handcuffs (i.e., the primary lock and the double lock), some embodiments may include luminescent material on one of the locking mechanisms. Furthermore, the luminescent material may take many forms, for example, the luminescent material may be in the form of luminescent adhesives that may be applied to the handcuffs after they are manufactured. It is intended that the following claims be interpreted to embrace all such variations and modifications.

1. A physical restraint device comprising a primary locking mechanism and a secondary locking mechanism, wherein each locking mechanism includes a luminescent material.

2. The physical restraint device of claim 1, wherein the luminescent material comprises a self-luminous material.

3. The physical restraint device of claim 2, wherein the self-luminous material comprises tritium.

4. The physical restraint device of claim 1, wherein the luminescent material utilizes energy from light source to provide light.

5. The physical restraint device of claim 4, wherein the luminescent material comprises phosphorus.

6. The physical restraint device of claim 1, wherein the luminescent material is adhesively attached to the physical restraint device.

7. (Canceled).

8. The physical restraint device of claim 1, wherein the physical restraint device comprises handcuffs.

9. The physical restraint device of claim 1, wherein luminescence is provided without electrical power.

10. A method of manufacturing a physical restraint device, comprising:
providing a primary locking mechanism to the physical restraint device; and providing a secondary locking mechanism to the physical restrain device, wherein the primary and secondary locking mechanisms includes a luminescent material.

11. The method of claim 10, further comprising providing an unlocking mechanism to the physical restraint device wherein the unlocking mechanism includes a luminescent material.

12. The method of claim 10, wherein the luminescent material comprises a self-luminous material.

13. The method of claim 12, wherein the self-luminous material comprises tritium.

14. The method of claim 10, wherein the luminescent material utilizes energy from light source to provide light.

15. The method of claim 14, wherein the luminescent material comprises phosphorus.

16. The method of claim 10, further comprising providing the luminescent material using adhesives.

17. The method of claim 10, wherein the physical restraint device comprises handcuffs.

18. The method of claim 10, wherein luminescence is provided without electrical power.

19-20. (Canceled).

21. The physical restraint device of claim 6, wherein adhesively attaching includes the use of stickers.

22. The physical restraint device of claim 6, wherein adhesively attaching includes the use of glue.

23. The method of claim 16, wherein the adhesives include stickers.

24. The method of claim 16, wherein the adhesives include glue.
